(19) United States
(12) Patent Application Publication
(10) Pub. No.: US 2026/0351649 A1
(43) Pub. Date: Nov. 5, 2026

(54) Bipolar Plate for Fuel Cells

(71) Applicant: Nanyang Technological University, Singapore (SG)

(72) Inventors: Bin Miao, Singapore (SG); Lan Zhang, Singapore (SG); Qinglin Liu, Singapore (SG); Weike Zhang, Singapore (SG); Ovi Lian Ding, Singapore (SG)

(21) Appl. No.: 19/484,828

(22) PCT Filed: May 15, 2024
(86) PCT No.: PCT/SG2024/050316

§ 371 Date: Nov. 14, 2025

(30) Foreign Application Priority Data
May 23, 2023 (SG) 10202301450R

(51) Int. Cl. H01M 8/2483; H01M 8/0263; H01M 8/0267; H01M 8/1004

(52) U.S. Cl. CPC H01M 8/2483; H01M 8/0263; H01M 8/0267; H01M 8/1004

(57) ABSTRACT

A bipolar plate for fuel cells and other applications is a unitary body with a grand sunken channel defining a primary zone The bipolar plate includes a border extending away from the primary zone to form a flange. Inlets and outlets are defined in the primary zone spaced apart from the border. All channel elements are non-contiguous with the border, disposed wholly in the primary zone, and are full height relative to the first plane. The planar flow path is defined by a flow height. The flow height is a uniform full height from the inlet to the outlet. The bipolar plate may be formed in a single stamping process.

### RELATED APPLICATION

This application claims the benefit of priority to the Singapore application no. 10202301450R filed May 23, 2023, the contents of which are hereby incorporated herein by reference in their entirety for all purposes.

### TECHNICAL FIELD

The present disclosure relates to structures for directed fluid flow or distribution, and more particularly to plate-like components suitable for use in fuel cells, electrolyzers, electrochemical apparatus, and other such applications.

### BACKGROUND

A fuel cell includes a negative electrode (also referred to as an anode) and a positive electrode (also referred to as a cathode), with an electrolyte (which may be in the form of a membrane) disposed between the anode and the cathode. In operation, a fuel, such as hydrogen, is supplied to the anode, and air is supplied to the cathode. Hydrogen at the anode is spilt into protons and electrons. The electrons may travel through the electrically conductive metal to a current collector, resulting in electricity flowing in an external circuit, while the protons travel through the electrolyte to the cathode. At the cathode, the protons, the electrons, and oxygen (from the supplied air) combine to produce water. In this manner, the fuel cell can be used to electrically power other devices. A typical fuel cell requires various fluids to be supplied non-stop in the course of operation, and may therefore serve to illustrate the technical challenges faced in directing fluid flow in limited physical spaces.

### SUMMARY

In one aspect, a bipolar plate includes a unitary body having: a first surface; a second surface; a primary zone; a border; two or more apertures; and a plurality of channel elements. The second surface is opposite the first surface. The primary zone defines a first plane. The border is continuous along an entire perimeter of the primary zone, and extends away from the primary zone to form a flange wholly disposed on a second plane. The second plane is parallel to and axially spaced apart from the first plane to define a full height between the first plane and the second plane. The two or more apertures include an inlet and an outlet, both the inlet and the outlet being defined in the primary zone at one of the first surface and the second surface. The plurality of channel elements is formed wholly in the primary zone and characterized by the full height relative to the first plane, at least one of the plurality of channel elements at least partially defining a planar flow path extending from the inlet to the outlet, the planar flow path being disposed on the first plane and defined by a flow height relative to the first plane, the flow height being a uniform full height from the inlet to the outlet.

The bipolar plate may further include an aperture wall partially disposed about each of the two or more apertures, each of the two or more apertures extends through a thickness of the unitary body between a first opening defined in the primary zone at the first surface and a second opening defined in the primary zone at the second surface. The aperture wall disposed at the first opening forms a corresponding recessed element at the second surface, the recessed element being partially disposed about the second opening.

In another aspect, a module may include: a plurality of a bipolar plate; a first surface; a second surface; a primary zone; a border; a plurality of apertures; and a plurality of channel elements. The second surface is opposite the first surface. The primary zone defines a first plane. The border is continuous along an entire perimeter of the primary zone, and extends away from the primary zone to form a flange wholly disposed on a second plane. The second plane is parallel to and axially spaced apart from the first plane to define a full height between the first plane and the second plane. The plurality of apertures is defined in the primary zone and non-contiguous with the border, each of the plurality of apertures providing fluidic communication through a thickness of the unitary body between the first surface and the second surface. The plurality of channel elements is formed wholly in the primary zone and characterized by the full height relative to the first plane to at least partially define a planar flow path from one of the plurality of apertures to another of the plurality of apertures along one of the first surface and the second surface, the plurality of channel elements being non-contiguous with the border. The plurality of the bipolar plate are stacked together along an axis normal to the first plane.

In yet another aspect, a method of forming the bipolar plate includes: stamping a metal blank in a first direction to form the primary zone, the primary zone being displaced by a full height relative to an unstamped area; and stamping the primary zone in a second direction to form one or more channel elements nested in the primary zone, each of the one or more channel elements being displaced by the full height relative to the primary zone.

### BRIEF DESCRIPTION OF THE DRAWINGS

Various embodiments of the present disclosure will be described with reference to the following figures:

FIG. 1A is an exploded perspective view of a module with bipolar plates according to embodiments of the present disclosure;

FIG. 1B shows an example of a cell;

FIG. 1C and FIG. 1D schematically illustrate a module formed of cells using bipolar plates according to embodiments of the present disclosure;

FIG. 2 is a perspective view of a bipolar plate according to embodiments of the present disclosure;

FIG. 3A and FIG. 3B are planar views of opposite surfaces of the bipolar plate of FIG. 2;

FIG. 4A and FIG. 4B are cross-sectional views of the bipolar plate of FIG. 3A;

FIG. 5A to FIG. 5C are schematic diagrams of a method of making the bipolar plate, a sub-assembly with reaction layers, and a sub-assembly with a cooling layer, according to embodiments of the present disclosure;

FIG. 6A is a simplified schematic plan view of the bipolar plate showing a possible placement of the channel elements in the active area;

FIG. 6B to FIG. 6D are schematic drawings of various exemplary configurations of the active area;

FIG. 7A is a cross-sectional view of the inlet/outlet zone;

FIG. 7B and FIG. 7C are magnified views of an aperture that can serve an inlet/outlet to different surfaces of the bipolar plate;

FIG. 8A is another cross-sectional view of the inlet/outlet zone;

FIG. 8B is a magnified plan view of the inlet/outlet region;

FIG. 9A to FIG. 9C are images showing various models of fluid flow channels used in the simulation experiments;

FIG. 10 is a graph showing simulation results of the achievable current density;

FIG. 11 is a perspective view of the bipolar plate showing one possible combination of the inlet/outlet gaskets;

FIG. 12 is a perspective view of the bipolar plate showing another possible combination of the inlet/outlet gaskets;

FIG. 13 is a schematic plan view of an embodiment of the bipolar plate showing planar flow paths;

FIG. 14 is an exploded perspective view of a part of a module according to one embodiment;

FIG. 15 shows a part of the module of another embodiment with distinct flow paths therein for different fluids;

FIG. 16A and FIG. 16B schematically illustrate various ways of configuring a module using bipolar plates of the present disclosure;

FIG. 17 is a partial drawing of a conventional stack showing bipolar plates welded to one another;

FIG. 18 is a partial drawing of a bipolar plate showing a cathode face and an anode face on opposite surfaces of the bipolar plate; and

FIG. 19 is a diagram illustrating a supply chain and various applications of the proposed bipolar plate.

### DETAILED DESCRIPTION

The following detailed description is made with reference to the accompanying drawings, showing details and embodiments of the present disclosure for the purposes of illustration and to aid understanding, and not to be limiting. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

As used herein, the term “and/or” includes any and all combinations of one or more of the associated listed items.

The word “exemplary” is used herein to mean “serving as an example, instance, or illustration.” Any embodiment described herein as “exemplary” is not necessarily to be construed as preferred or advantageous over other embodiments.

As used herein, the singular ‘a’ and ‘an’ may be construed as including the plural “one or more” unless apparent from the context to be otherwise.

The terms “about” and “approximately” as applied to a stated numeric value encompasses the exact value and a reasonable variance as will be understood by one of ordinary skill in the art, and the terms “generally” and “substantially” are to be understood in a comparable manner, unless otherwise specified.

Some processes may be described in terms of steps merely to aid understanding and/or for convenient reference. The delineation between one step and another step may be described as such merely for convenient reference in the present disclosure. It will be understood that in actual implementation there may not be a clear division or transition from one step to another subsequent step. There may be a certain amount of overlap among the steps and/or more than one step may occur or be performed concurrently in time, etc.

As used herein, the term “concurrent”, or “concurrently”, is used loosely to refer to two or more occurrences (or events) that at least partially overlap in time. The occurrences may or may not start at the same time instant and/or end at the same time instant.

Terms such as “first” and “second” are used in the description and claims only for the sake of brevity and clarity, and do not necessarily imply a priority or order, unless required by the context.

As used herein, the expression “directing fluid flow” or the like may be understood to refer generally to having physical structures shaped and/or disposed to permit fluid flow in a certain region or to prevent fluid flow in a certain region. In other words, the expression “directing fluid flow” or the like, as used herein, does not mean that such structures are required to be powered or have moving parts to displace fluid.

### Module

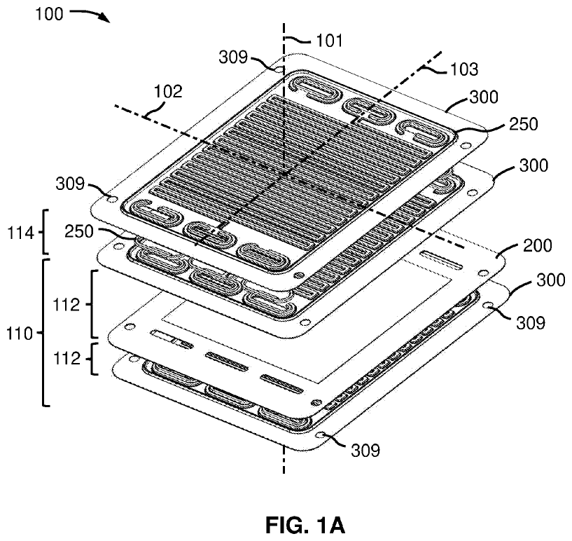

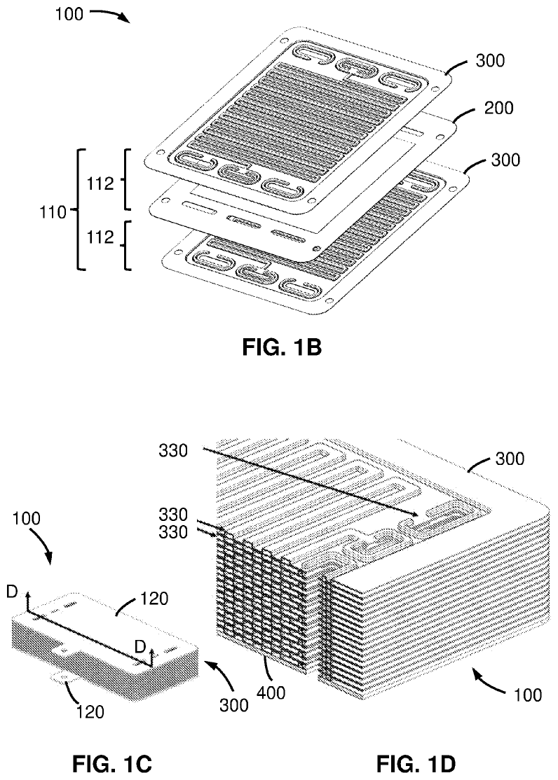

FIG. 1A is a perspective view of a module 100 according to various embodiment of the present disclosure. The module 100 is shown exploded along a normal axis 101. The module 100 may be disposed in any of various directions when in operation, but for easy reference, the normal axis 101 may be defined generally as an axis that is perpendicular to the bipolar plate 300. A longitudinal axis 103 may define longitudinal directions perpendicular to the normal axis 101 and extending from one inlet/outlet region to another inlet/outlet region of the bipolar plate 300. A transverse axis 102 may define transverse directions perpendicular to the normal axis 101 and the longitudinal axis 103.

In the present disclosure, a “cell” 110 refers to a basic unit of an electricity generating apparatus. A cell 110 may include two reaction layers 112 with a membrane 200 sandwiched between the two reaction layers 112, as shown in FIG. 1B. One of the reaction layers 112 may be defined by a cathode channel of a bipolar plate 300 and the membrane 200. Another of the reaction layers 112 may be defined by an anode channel of another bipolar plate 300 and the membrane 200. The term “cell voltage” may be understood in terms of a voltage generated across the cell 110.

Referring again to FIG. 1A, the module 100 may include one or more cells 110. The module 100 may include one or more cooling layers 114 distributed among the one or more cells 110. Various gaskets 250 may be provided to improve a seal between a bipolar plate 300 and other components of the module 100.

In some examples, the module 100 or the cell 110 may refer more generally to an apparatus operable to carry out electrochemical processes, of which the fuel cell is one example. FIG. 1C illustrates an example of a module 100 in which plurality of the bipolar plates 300 aligned in a stack forming a manifold assembly between two current collectors or end plates 120. FIG. 1D shows a magnified cross-sectional view of the module 100 along cutting plane D-D. The raised/recessed guide features 330 may include respective anode channels and the cathode channels at opposite surfaces of the bipolar plate 300, as well as aperture walls at the inlets/outlets. The raised/recessed guide features 330 may be distributed in an asymmetrical pattern on the bipolar plate 300. The asymmetric configuration facilitates alignment and easy assembly, as well as a good contact between the anode channels and the cathode channels. A plurality of the bipolar plates 300 and at least one membrane 200 may be coupled together at multiple assembly holes 309. For example, a bolt may be passed through aligned ones of the assembly holes 309 and threadably secured with a nut.

For the sake of brevity, the terms “stack”, “assembly”, and “module” may be used interchangeably in the present disclosure to refer to a plurality of bipolar plates 300 coupled in alignment with one another. The terms “fuel cell”, “fuel cell stack”, “fuel cell module” may be used interchangeably in the present disclosure to refer to an apparatus that includes at least a cell 110 for use as a fuel cell.

### Bipolar Plate

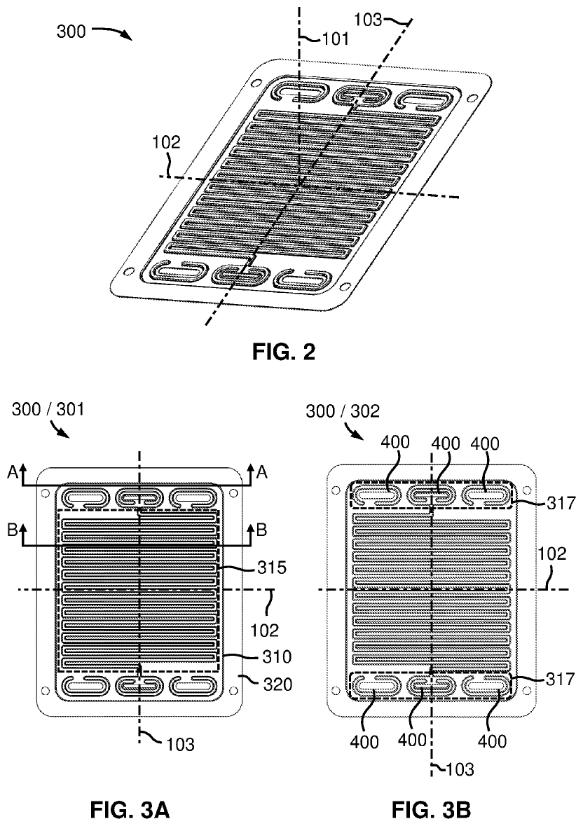

FIG. 2 shows an example of the bipolar plate 300 according to various embodiments of the present disclosure. The bipolar plate 300 may be an integral or unitary article formed by stamping a metal blank. The bipolar plate 300 may be a substantially planar article having a thickness defined between a first surface 301 and a second surface 302, in which the first surface 301 and the second surface are opposite to one another. FIG. 3A is a plan view of the first surface 301 of the bipolar plate 300. FIG. 3B is a plan view of the second surface of the bipolar plate 300.

As shown by FIG. 2, FIG. 3A, and FIG. 3B, the bipolar plate 300 may be configured with a rotational symmetry of order two, e.g., the bipolar plate 300 has an identical configuration if rotated about the normal axis 101 by 180 degrees. If the bipolar plate in FIG. 2 is disposed in a ‘horizontal’ plane, rotating the bipolar plate 300 about the normal axis 101 for 180 degrees will rotate the bipolar plate ‘horizontally’ to show the same view of the bipolar plate 300 before and after rotation.

As shown by FIG. 3A and FIG. 3B, the bipolar plate 300 may be configured such that the first surface 301 (e.g., as shown in FIG. 3A) is a mirror image about the longitudinal axis 103 of the second surface (e.g., as shown in FIG. 3B), or vice versa. Preferably, all features shown in FIG. 3A and FIG. 3B are formed by a single stamping process such that the entirety of either surface is an inverse of the other surface.

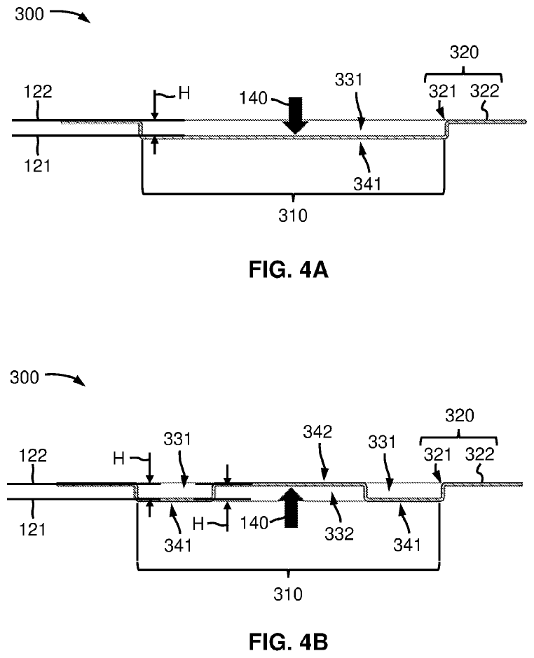

FIG. 4A is a cross-sectional view of the bipolar plate 300 of FIG. 3A along the cutting plane A-A. Referring to FIG. 4A, in one aspect, a method according to embodiments of the present disclosure includes a stamping process. The stamping process creates a deformation 140 of a metal blank (flat or substantially flat metal sheet) forming a “grand sunken channel” or a primary zone 310, with a border 320 surrounding the entire perimeter 321 of the primary zone 310. The border 320 extends away from the perimeter 321 of the primary zone 310 in the form of a flange 322 that is disposed at a different plane from the primary zone 310. For example, the primary zone 310 may define a first plane 121 and the flange 320 may be wholly disposed on a second plane 122, in which the first plane 121 and the second plane 122 are parallel or substantially parallel to one another. The first plane 121 and the second plane 122 are spaced apart by a height (H) that corresponds to the stamping depth of the stamping process.

In the present disclosure, the term “primary zone” 310 may refer to entire region within the border 320. The primary zone 310 may correspond to a channel element 331 at one surface of the bipolar plate 300 and to a raised element 341 at the opposite surface of the bipolar plate 300. The flange 322 extends continuously along the entire perimeter 321 of the primary zone 310.

FIG. 4B is a cross-sectional view of the bipolar plate 300 of FIG. 3A along the cutting plane B-B. In another aspect of the method based on one stamping process, the primary zone 310 may be subject to small deformation to form channel elements 332 in the primary zone 310. The channel elements 332 at one surface of the bipolar plate 300 corresponds to raised elements 342 at the other surface of the bipolar plate 300.

According to embodiments of the present disclosure, each of all the channel elements 331 at the first surface 301 of the bipolar plate 300 is characterized by a full height (H), and each of all the channel elements 332 at the second surface 302 of the bipolar plate 300 is characterized by a similar full height (H). The flange 322 and the “base” of the grand sunken channel are spaced apart by a similar full height (H). For the sake of brevity, the “base” and the “primary zone” may be referred to interchangeably in the present disclosure.

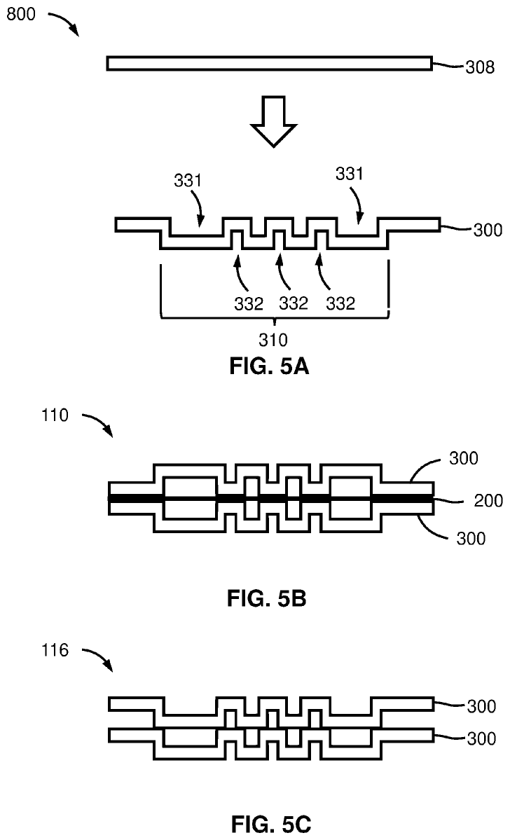

FIG. 5A schematically illustrates a method 800 of forming a bipolar plate 300 from a metal blank 308. The method 800 may include a stamping process. The method 800 may be a single stamping process. The bipolar plate 300 may be formed with channel elements 331,332 on opposite surfaces of the bipolar plate 300. The channel elements 332,332 may form part of two distinct flow paths 500 for two different fluids (gaseous or liquid). For example, the channel elements 331 at the first surface 301 may serve as anode channels and the channel elements 332 at the second surface 302 may serve as cathode channels of a fuel cell or module 100.

FIG. 5A shows the bipolar plate 300 as a plate-like article with complementary nested elements. In the present disclosure, the term “nested” may refer to one or more small structures that are formed within an area of a larger structure. For example, the channel elements 332 or the raised elements 342 are nested within one larger channel element 331 or within the primary zone 310.

Referring to FIG. 5B, the method 800 may further include making a sub-assembly, such as a cell 110 with at least two reaction layers 112. For example, the method may include making a cell 110 by coupling two bipolar plates 300 together with a membrane 200 clamped between the two bipolar plates 300.

Referring to FIG. 5C, the method 800 may further include making a cooling sub-assembly 116 by coupling two bipolar plates 300 together.

In yet another aspect of the method 800, the sub-assemblies 110,116 and individual bipolar plates 300 may be assembled in a mix-and-match manner, to form stacks of various different combinations and/or permutations of reaction layers 112 and cooling layers 114.

Referring again to the nested configuration of the proposed bipolar plate 300, channel elements 331,332 on both surfaces of the bipolar plate 300 may be drawn or stamped to full height (H). The channel elements 331,332 have the same full height (H) for the channel height.

In contrast, in a conventional stamped plate without the proposed nested configuration (e.g., without a grand sunken channel or a primary zone 310), taking into consideration the thickness of the material of the bipolar plate, the channels at one surface will inevitably be unable to achieve full height. Often times, the conventional bipolar plate will need to provide cathode channels at half-height even if the anode channels are formed to be full-height. Blockages may occur at the half-height channels of a conventional bipolar plate.

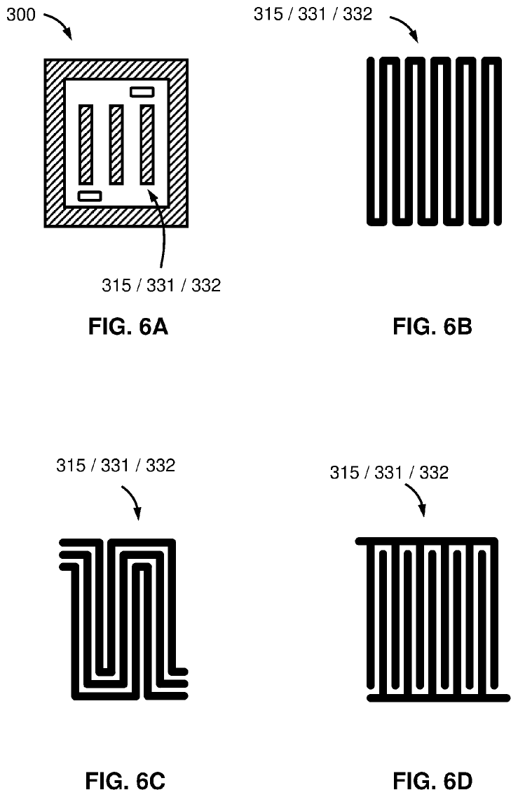

Referring again to FIG. 3A, the channel elements 331/332 may define an active area 315 over which the reactant fluids are directed along respective flow paths. FIG. 6A is a simplified schematic drawing of the proposed bipolar plate 300 showing an active area 315 defined by a plurality of parallel channel elements 331/332. FIG. 6B schematically illustrates another example of a portion of the active area 315 in which the channel element 331/332 is configured with a serpentine shape. FIG. 6C schematically illustrates another example of a portion of an active area 315 in which the channel elements 331/332 are disposed in a parallel serpentine configuration. FIG. 6D schematically illustrates yet another example of a portion of an active area 315 in which the channel elements 331/332 are disposed in an interdigital configuration.

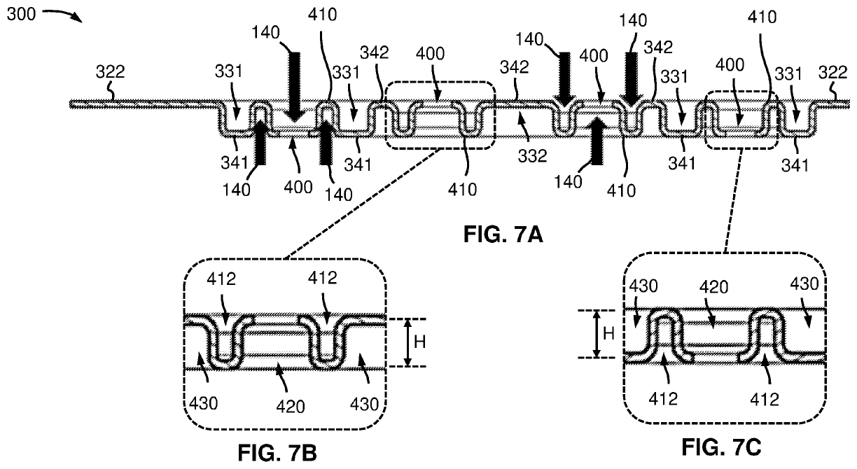

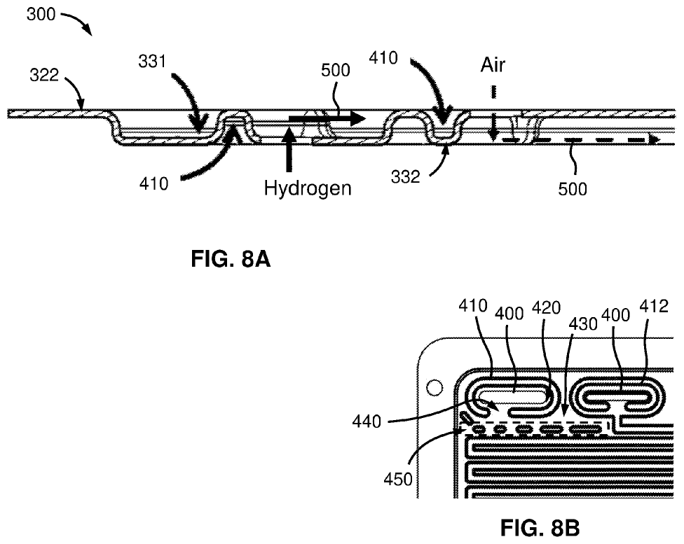

Inlet/Outlet zone Referring again to FIG. 3B, FIG. 7A to FIG. 8B show an inlet/outlet zone 317 of an embodiment of the proposed bipolar plate 300. The inlet/outlet region 317 includes apertures 400 for the passage of fluid into or out of the reaction layer 112 or the cooling layer 114. Each of the apertures 400 is disposed in the primary zone 310.

### Forming Apertures

In one aspect of the method 800, the stamping process may include a punching step to form a plurality of apertures 400 within an inlet/outlet zone 317. The inlet/outlet zone 317 is entirely disposed in the primary zone 310. The bipolar plate 300 includes two inlet/outlet zones 317, preferably located at opposing ends with the active area 315 in between the two inlet/outlet zones 317.

FIG. 7A shows exemplary deformation 140 to provide each aperture 400 in in a channel element 331/332 with an aperture wall 410 protruding about the aperture 400. In the example shown, a plurality of apertures 400 may be punched through the thickness of the bipolar plate material. As shown in the partial magnified views of FIG. 7B and FIG. 7C, the aperture wall 410 defines an inner flow zone 420 and an outer flow zone 430 on either side of the aperture wall 410.

According to another embodiment, a punch and die set is configured to form the bipolar plate 300 in one stamping process. One stamping process is understood to refer to a process using one punch and die set. One stamping process may include one or more draws (deformation of the material) without changing the punch or moving to another stamping equipment to form different stamped elements on the same plate.

According to other embodiments, the bipolar plate 300 may be formed in more than one stamping process. In another example, the primary zone 310 and various stamped channel elements 331/332, raised elements 341/342 and aperture walls 410 may be concurrently formed in a step, and the plurality of apertures 400 may be formed in a separate aperture-forming step.

In yet another embodiment, the plurality of apertures 400 may be concurrently formed in an aperture-forming step, followed by a subsequent step in which the primary zone 310 and various channel elements 331/332 are concurrently formed.

In still another embodiment, the primary zone 310 may be formed in a first feature-forming step. The first step may be subsequently followed by an aperture-forming step in which the plurality of apertures 400 are formed in the primary zone 310. The aperture-forming step may then be followed by a second feature-forming step in which various channel elements 331/332 are formed in the primary zone 310 The aperture 400 may be described as extending through the thickness of the bipolar plate material, with a first opening leading to the first surface and a second opening leading to the second surface. When two or more bipolar plates are in assembly, the aperture of one bipolar plate is in alignment with a corresponding aperture of the other bipolar plate such that the aligned apertures define a pipeline for fluid flow in the normal direction. The normal direction is perpendicular to the first plane or the second plane as defined by major surfaces of the bipolar plate.

The apertures 400 may be disposed anywhere within the primary zone 310. Optionally and preferably, two of the apertures 400 are disposed at opposing ends to serve respectively as the first inlet and the first outlet for a first fluid at the first surface 301 of the bipolar plate 300. The bipolar plate 300 further defines another two apertures 400 that are disposed at opposing ends to serve respectively as the second inlet and the second outlet for a second fluid at the second surface 302 of the bipolar plate 300. The bipolar plate 300 may define yet another two apertures 400 that are disposed at opposing ends to serve respectively as the coolant inlet and the coolant outlet for the coolant to be flowed across the first surface 301 or the second surface 302.

FIG. 8A shows the apertures 400, the channel elements 331/332, and the aperture walls 410 cooperate to direct different fluids (e.g., hydrogen, air, etc.) along separate fluid paths. Each of a first inlet and a first outlet is partially surrounded by an aperture wall 410 at the first surface 301. Each of a second inlet and a second outlet is partially surrounded by an aperture wall 410 at the second surface 302. Each of a coolant inlet and a coolant outlet is partially surrounded by an aperture wall at the selected surface.

FIG. 8B shows an example of the aperture wall 410. Each aperture 400 is spaced apart from the border 320 and wholly disposed in the primary zone 310. An aperture wall 410 is formed at one surface of the bipolar plate 300 in proximity to and spaced apart from each aperture 400. The aperture wall 410 is formed as a full height (H) element. The aperture wall 410 is formed as an “isolated island” that is spaced apart from the aperture 400 and other channel elements 331/332 as well as from the border 320. As used herein, the terms “aperture wall” 410 and “isolated island” may therefore be used interchangeably.

The aperture wall 410 is spaced apart from the aperture 400 to define an inner flow zone 420 on one side of the aperture wall 410. The inner flow zone 420 is characterized by a full height (H) and a relatively narrow width. The aperture wall 410 is spaced apart from the border 320 to define an outer flow zone 430 on the other side of the aperture wall 410. The outer flow zone 430 is characterized by a full height (H) and is contiguous with the active area 315 and with the rest of the primary zone 310.

The aperture wall 410 partially surrounds the aperture 400. The ends of the aperture wall define a slot channel 440 providing fluid communication between the inner flow zone 420 and the outer flow zone 430. The slot channel 440 is characterized by a full height (H) and a relatively narrow width compared to the primary zone 310. The slot channel 440 is positioned to direct fluid flow to/from the aperture 400 from/towards the active area 315 or the center of the bipolar plate 300. The slot channel 440 may be located between the aperture 400 and the active area 315 of the surface 301/302. In some examples, the aperture wall 410 may be described as being C-shaped.

In some examples, the aperture wall 410 may be shaped as an asymmetrical isolated island. For example, the slot channel 440 may be positioned at an offset relative to a center of the aperture 400. The asymmetrical aperture wall 410 facilitates better engagement and/or clamping of an inlet/outlet gasket disposed at the aperture.

The inner flow zone 420 and the outer flow zone 430 are in fluid communication via the slot channel 440. The inner flow zone 420, the slot channel 440, and the outer flow zone 430 are all disposed on the same plane such that the fluid flow from the aperture 400 via the slot channel 440 to the rest of the primary zone 310 is continuously under conditions of a full height (H) channel. If the aperture 400 is used as an outlet, the fluid flow will be directed from the inlet, across the active area 315, through the slot channel 440, and toward the aperture 400 to exit the layer. Various other flow directing elements 450 or channel elements 331/332 may be provided to direct fluid flow direction or to facilitate fluid flow around corners and/or turns.

In conventional fuel cells, fluid flow through an aperture to a surface of a bipolar plate is typically accompanied by a pressure drop and energy losses. In contrast, the aperture wall 410 define a consistently full height (H) flow path from the full height (H) inner flow zone 420 through a full height (H) slot channel 440 which help to re-distribute the fluid flow near the aperture 400 while providing conditions that reduce pressure drop and reduce energy losses.

The aperture walls 410 further enhance electrical conductivity of the bipolar plates 300. In some embodiments, the aperture walls 410 of adjacent bipolar plates 300 may partially mate with one another.

### Inverse of the Aperture Wall

The aperture wall 410 may be formed in the course of the stamping process that forms the other channel elements 331/332. The aperture wall 410 at one surface corresponds to an inverse of the aperture wall 410 at the other surface.

For example, the aperture wall 410 at the first surface 301 corresponds to a recessed element 412 at the second surface of the same bipolar plate. The recessed element 412 may receive a gasket 250. The inner flow zone 420 at the first surface 301 corresponds to a part of a raised element at the second surface. The slot channel at the first surface may correspond to another part of the raised element at the second surface. The raised element at the second surface prevents fluid communication between the aperture 400 and the second surface. The gasket 250 disposed in the recessed element 412 further seals the aperture 400 off from the second surface.

The same applies to an aperture wall 410 at the second surface. For example, the aperture wall 410 at the second surface corresponds to a recessed element 412 at the first surface of the same bipolar plate 300. The recessed element 412 may receive a gasket 250. The inner flow zone at the second surface corresponds to a part of a raised element at the first surface. The slot channel at the second surface may correspond to another part of the raised element at the first surface. The raised element at the first surface prevents fluid communication between the aperture and the first surface. The gasket 250 disposed in the recessed element 412 further seals the aperture 400 off from the first surface.

### Full Height Channels

In the present disclosure, the term “full height” (H) refers to the height/depth of the tallest/deepest channel element 331/332 of the bipolar plate 300, and the term “half-step” refers to a height/depth of a channel that is half or approximately half of the full height.

According to embodiments of the present disclosure, all guide features 330 (e.g., including all the channel elements 331/332 and aperture walls 410) of the bipolar plate 300 are drawn or stamped to the same height which is designated herein as “full height” (H), such that all channel elements 331/332 define full height (H) channels. The bipolar plate 300 of the present disclosure does not need to include half-step channels to manage pressure drop along the flow paths, which is an advantage when considering manufacturability and manufacturing efficiency.

The proposed bipolar plate 300 with the “grand sunken zone” or primary zone 310 configuration allows for full penetration on both surfaces of the metal blank in the stamping process, resulting in full-height channels at both surfaces 301/302 of the bipolar plate 300. In other words, the proposed bipolar plate 300 is formed with channel elements 331/332 that define the same channel height (H) on either surface of the bipolar plate 300.

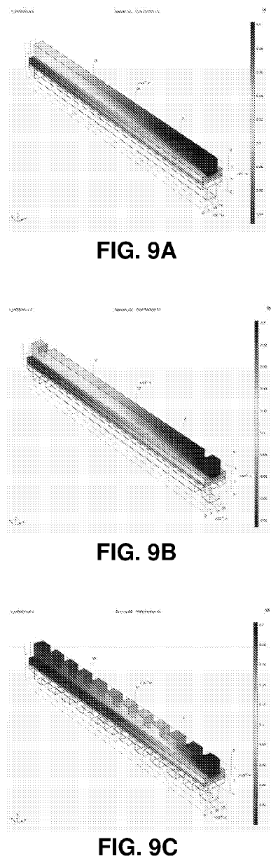

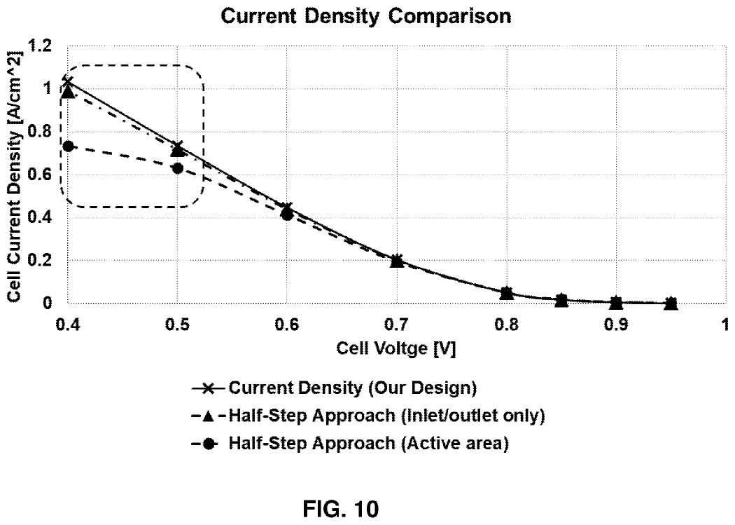

Simulations were performed for a fluid flow channel that is wholly full height (FIG. 9A), to model a cell 110 with the proposed bipolar plates 300. For comparison, simulations were also performed for a full-height fluid flow channel that includes half-step portions at the inlet and at the outlet but full height (FIG. 9B), to model a conventional cell. Simulations were also performed for a fluid flow channel that includes half-step portions at an active area (corresponding to the primary zone) (FIG. 9C) to model another example of the conventional cell. The cell current density was compared across a range of cell voltage values. As shown in FIG. 10. the simulation results showed a significant improvement in the performance of the cell current density for the cell 110 according to embodiments of the present disclosure, in which all channel elements 331/332 define full-height (H) channels, even at the inlet and the outlet. The maximum cell current density achieved by the cell using the proposed bipolar plates 300 is higher than either of examples modelling conventional cells.

The simulation results of the conventional model with many half-step portions show the poorest performance in cell current density. In practical applications, the negative impact of half-step portions is expected to be amplified by the presence of multiple intersections of multiple channels in a fuel cell. In practical applications, the difference between the proposed fuel cell and the conventional fuel cell is therefore expected to be even more significant.

### Gasket

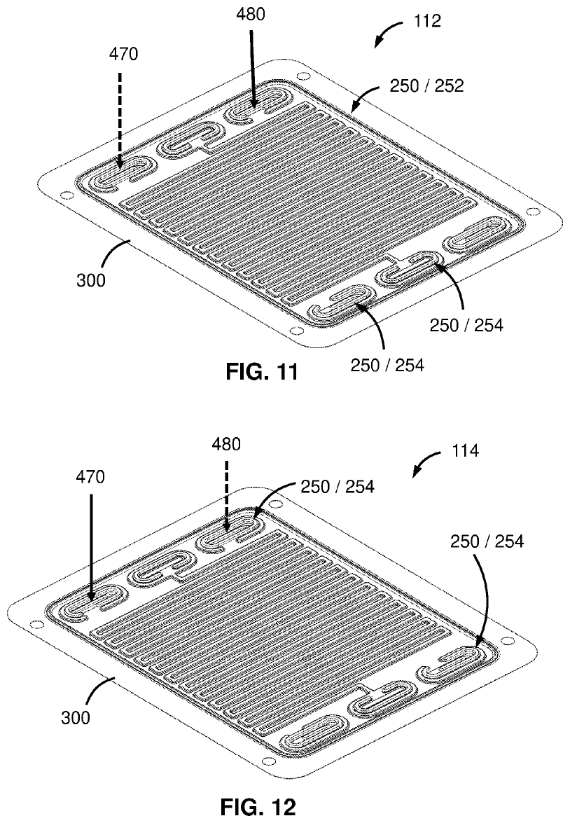

As shown in FIG. 11 and FIG. 12, a plurality of gaskets 250 of various shapes and sizes may be used with the bipolar plate 300 or the module 100. FIG. 11 shows a possible combination and distribution of gaskets 250 so that the layer at the surface shown may be used as a reaction layer 112 in a fuel cell module 100. For example, the cooling manifold 470 may be closed and the gas manifold 480 may be opened to supply reactant gas. FIG. 12 shows a possible combination and distribution of gaskets 250 so that the layer at the surface shown may be used as a cooling layer 114. For example, the cooling manifold 470 may be opened for the cooling layer 114 and the gas manifold 480 may be closed to isolate the reactant gas from the coolant.

In assembly, a border gasket 252 may be disposed at the border to improve a seal between the membrane 200 and a bipolar plate 300. The border gasket 252 may rest upon a shallow step formed along the inner perimeter of the flange 322.

An aperture 400 at a surface 301/302 may be provided with an inlet/outlet gasket 254. The inlet/outlet gasket 254 may be formed with a gasket height such that in assembly the inlet/outlet gasket 254 can serve to close off the respective manifold. In a module 100 or in a stack, with two sequential bipolar plates 300 coupled together with a membrane 200 disposed in between, the inlet/outlet gasket 354 may be slightly compressively held in place between the membrane 200 and one of the bipolar plates 300.

In some cases, the inlet/outlet gasket 254 is disposed between the aperture 400 and the aperture wall 310. The inlet/outlet gasket 254 is prevented from displacement by the aperture wall 410.

In other cases, the inlet/outlet gasket 254 is received in the recessed element 412, and the inlet/outlet gasket 254 is prevented from displacement by the part of the raised element surrounding the recessed element 412.

In some examples, the gasket 250 is a complete ring (O-gasket). The O-gasket may be disposed at the inner flow zone 420 of the aperture 400. In assembly, the O-gasket in effect blocks the slot channel 440 and prevents fluid communication between the aperture 400 and the surface of the bipolar plate 301/302.

In some examples, the gasket 250 is configured in an arcuate or bent shape, or as a C-shaped gasket (C-gasket). The C-gasket may be disposed at the inner flow zone of the aperture 400. In assembly, the C-gasket provides a gap in alignment with the slot channel 440 and allows fluid communication between the aperture 400 and the surface 301/302 of the bipolar plate 300.

In some examples, the inlet gasket corresponds to the aperture wall 410, with ends defining a gap therebetween (C-gasket). In assembly, the gap of the C-gasket is aligned with the slot channel 440 of the aperture wall 410.

In some examples, the C-gasket is configured to be received in the recessed element 412.

The aperture wall 410 and the raised element are each formed to be full height (H) elements. Either the aperture wall 410 and the raised element would at least partially surround a gasket 250 and provide a sufficient barrier to displacement of the gasket 250.

In some embodiments, the channel elements include longitudinal parallel portions. When two similarly configured bipolar plates are inversely coupled together with a membrane disposed in between (forming adjacent bipolar plates), the adjacent bipolar plates will match one another as the convex longitudinal parallel portions of the channel elements of the adjacent bipolar plates will abut, and the concave longitudinal parallel portions of the channel elements will form parallelly extending channels for fluid flow on either side of the membrane.

### Membrane

In a stack or module 100 of the present disclosure, the membrane 200 used may essentially be an unbroken sheet across the entire primary zone 310 or across the active area 315. The size of the membrane 200 is selected to enable the membrane to be clamped all around by the respective flanges 322 of adjacent bipolar plates 300.

In some examples, the overall size and shape of the membrane 200 corresponds to the overall size and shape of the bipolar plate 300 to provide a secure clamping of the membrane 200 between the flanges 322 of adjacent bipolar plates 300.

In some examples, the entire flange 322 may be in contact with the membrane 200.

In some examples, mating ones of raised elements 341/342 of the adjacent bipolar plates 300 may further sandwich the membrane 200 to provide further support to the membrane 200.

### Exemplary Directed Fluid Flow (Planar Flow Paths)

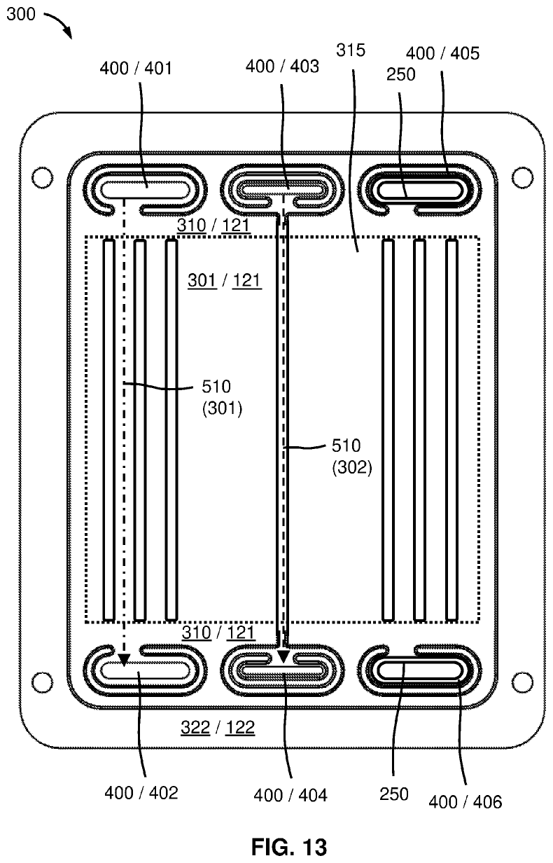

FIG. 13 is a schematic diagram of the bipolar plate 300 according to one embodiment of the present disclosure with a simplified active area 315 to better illustrate exemplary flow paths 500. The primary zone 310 (including the active area 315) is disposed on the first plane 121. The flange 322 is disposed on the second plane 122.

A planar flow path 510(301) extending across the first surface 301 from a first inlet 401 to a first outlet 402 is defined by the primary zone 310 (which includes the active area 315) and run parallel to the first plane 121 throughout the length of the planar flow path 510(301).

At the second surface 302, another planar flow path 510(302) extends across the second surface 302 from a second inlet 403 to a second outlet 404. The planar flow path 510(302) runs along the second surface 302 (parallel to the first plane 121) throughout the length of the planar flow path 510(302).

The apertures 400 serving as the first inlet 401 and the first outlet 402 are made to open to or be in fluid communication with the first surface 301 and not with the second surface 302 by use of a C-gasket at the first surface 301 and a O-gasket at the second surface 302.

The apertures 400 serving as the second inlet 403 and the second outlet 404 are made to open to or be in fluid communication with the second surface 302 and not with the first surface 301 by use of a C-gasket at the second surface 302 and a O-gasket at the first surface 301.

The apertures 400 serving as the third inlet 405 and the third outlet 406 may be closed to both the first surface 301 and the second surface 302 by use of an O-gasket at each of the first surface 301 and the second surface 302. Fluid flowing in this aperture will bypass the layers on either side of this bipolar plate 300.

The planar flow path 510 in a reaction layer 112 or in a cooling layer 114 that extends across the first surface 301 or the second surface 302 can be characterized by a constant flow height or a constant channel height (H) for the entire length of the planar flow path 510 from the inlet (one of the apertures 400) to the outlet (another of the apertures 400). This is possible because the aperture 400 opens directly at the primary zone 310 or at the first plane 121, and the planar flow path 510 is continuously extends parallel to the first plane 121 until the planar flow path 510 ends at the outlet.

As used herein, a reaction layer 112 refers to a layer defined between the membrane 200 and a bipolar plate 300 (serving as the anode surface or cathode surface), or to a layer in which a reactant fluid is flowed. The reactant fluid may include, but is not limited to hydrogen, oxygen, air, etc. A cooling layer 114 refers to a layer defined between two bipolar plates 300 (e.g., within no membrane in between the bipolar plates 300), or to a layer in which a coolant fluid is flowed.

According to embodiments of the present disclosure, either surface or both surfaces (e.g., the first surface 301 and/or the second surface 302) of the bipolar plate 100 may be used as part of a reaction layer 112 or a cooling layer 114.

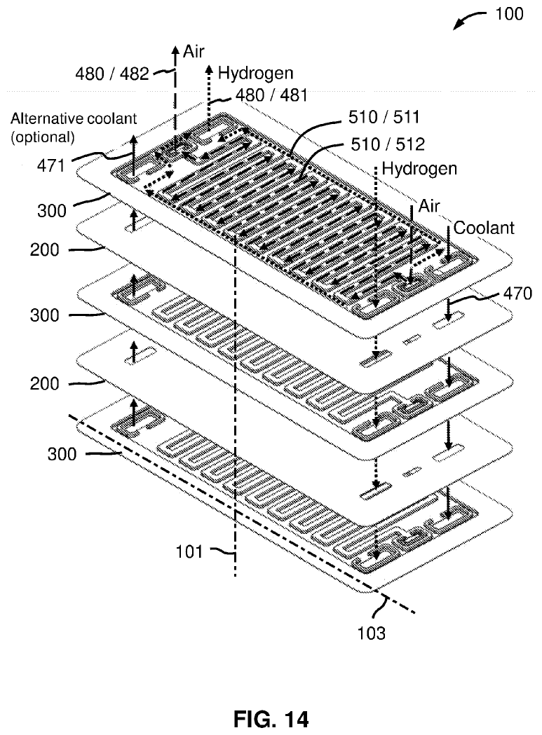

FIG. 14 shows a part of a module 100 in perspective view axially exploded along the normal axis 101 to show a configuration with alternately disposed bipolar plates 300 and membranes 200.

The hydrogen manifold 481, the air manifold 482, and the cooling manifold 470 provide axial flow paths that run through the layers. The manifolds branch out to respective layers such that each layer receives only one type of fluid. Distinct planar flow paths 510 are provided on either surface of the bipolar plate 300. For example, the hydrogen planar flow path 511 (shown in dotted lines) is disposed at one surface of the bipolar plate 300, while the air planar flow path 512 (shown in dashed lines) is disposed at the opposite surface of the bipolar plate 300. Optionally, a cooling manifold 470 may be provided. Optionally, an alternative coolant 471 may be provided.

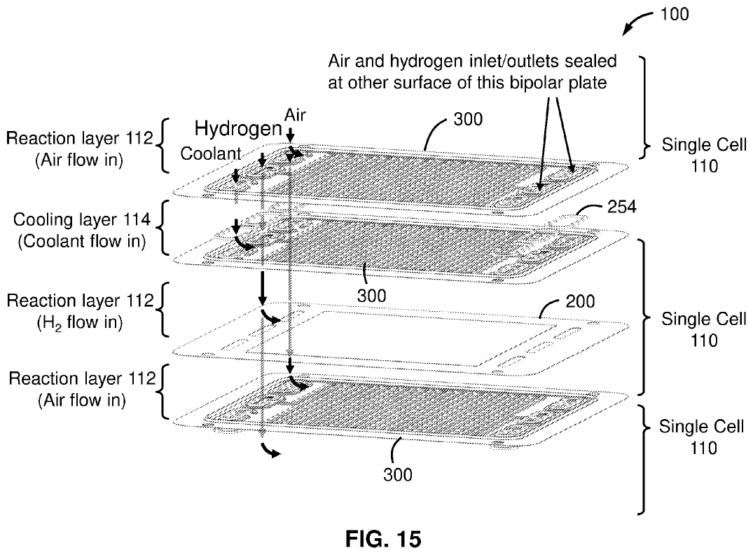

To further illustrate, FIG. 15 shows the distinct flow paths in an exemplary section of a module 100 according to another embodiment. In the cooling layer 114, hydrogen and air are separated by a gasket of the present disclosure, allowing only the coolant (cooling fluid) to flow into the cooling layer 114. At the inlets and outlets of the air and hydrogen bypass the cooling layer 114 to enter different reaction layers 112. The reaction layer 112 for hydrogen and the reaction layer for air are located at respective opposite surfaces of the bipolar plate 300, with corresponding inlet/outlet gaskets 254 serving as sealing rings with specific shapes (closed-loop or O-gasket) to enclose the gases. At the reaction layer, selected apertures 400 therefore serve as the respective pair of anode inlet/outlet for hydrogen or as the respective pair of cathode inlet/outlet for air (oxygen). At the cooling layer, selected apertures 400 similarly serve as the respective pair of coolant inlet/outlet for a coolant.

This configuration ensures not only the sealing of the cooling fluid but also avoids welding throughout the entire fuel cell stack, including both the reaction layer 112 and the cooling layer 114. The sealing of the entire stack is provided by the compression of the end plates of the module 100 and the configuration of the inlet/outlet gaskets 254 (sealing rings).

### Flexible Stack Configuration

In a module or a stack of bipolar plates 300, one or more cooling layers 114 may be provided. For example, a cooling layer 114 may be arranged alternatively among the reaction layers 112. Advantageously, the cooling layer 114 may be provided at either one or both surfaces 301/302 of any one of the bipolar plates 300 in the module 100.

In a module 100 of multiple layers, one or more of the multiple layers may be selected to a cooling layer 114, while other layers may be configured as reaction layers 112. According to embodiments of the present disclosure, each layer may be defined by two similar bipolar plates 300 that are coupled together at their respective flanges 322. To use the same layer as a reaction layer 112 instead of a cooling layer 114, a fuel gas (such as hydrogen) or air (as a source of oxygen) may be provided to the same layer. To use a layer as a cooling layer 114, a coolant (instead of hydrogen or oxygen source) may be provided to the layer.

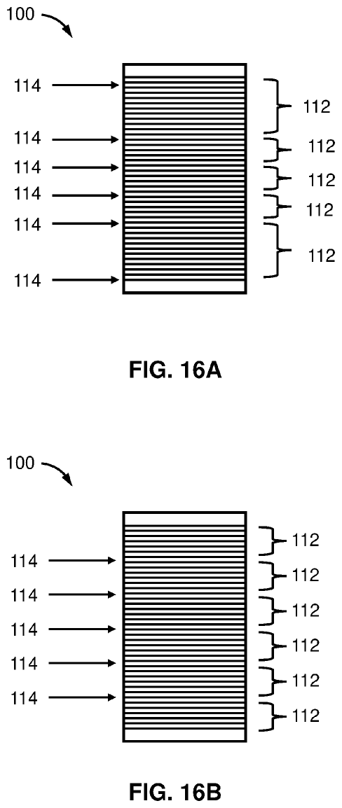

According to embodiments of the present disclosure, in a module 100 made of a stack of similar bipolar plates 300, the distribution of cooling layers 114 becomes a comparatively flexible configuration. For example, as schematically illustrated in FIG. 16A, the module 100 may be configured with a higher density of cooling layers 114 near the center of the stack of bipolar plates. In one example, in a module 100 of multiple layers, every third layer near the center of the stack may be a cooling layer 114, and every sixth layer near the end layers of the stack may be a cooling layer 114. This differential cooling at different parts of the same stack enables adequate cooling at the ends of the stack (where end plates help to conduct heat away from the stack) without undercooling near the center of the stack (where more heat may accumulate).

In another example, as schematically illustrated in FIG. 16B, cooling layers 114 may be regularly distributed among the reaction layers 112. For example, every third layer may be a cooling layer 114, with two reaction layers 112 disposed between two cooling layers 114.

Advantageously, the distribution of the cooling layers 114 may be adjusted according to the stack performance, operating mode of the stack, catalyst performance, etc. For example, in a calibration mode, responsive to a measured performance parameter of the stack falling out of a predetermined acceptable range, one or more layers in the stack may be selected to serve as a cooling layer 114 instead of a reaction layer 112.

Easy configuration or re-configuration of a layer as a reaction layer 112 or as a cooling layer 114 is possible with the bipolar plate 300 proposed herein at least in part because all the bipolar plates 300 used in the stack are similar to one another. For example, the configuration of a layer as a reaction layer 112 or as a cooling layer 114 may be easily done by selecting the appropriate apertures at each layer to be open or closed to a respective stream of fuel, air, or coolant.

As a result, manufacturability of a module or a fuel cell can be improved by use of the proposed bipolar plate. In one aspect, it is possible to use only one set of stamping mold (or one punch and die set) to form all the bipolar plates or all layers of one module or one fuel cell. In another aspect, the same bipolar plate configuration may be used to define any of a reaction layer and a cooling layer.

### Other Benefits

The foregoing description includes examples to show how a plurality of the proposed bipolar plate 300 may be assembled together to form a stack or a fuel cell module 100 without the need to solder or weld one bipolar plate 300 to another bipolar plate 300. This means that the material of the bipolar plate may be selected for better performance in terms of ductility (bendability), surface hardness, corrosion resistance, thermal conductivity, electrical conductivity, etc., with less regard to the solderability or weldability of the material. Stainless steels and aluminum, etc., are known to have poor solderability or are difficult to weld. Cast iron and chromium may even require the use of specialized solders or plating, which would add to the manufacturing costs. Plating would increase the thickness and overall height of a stack. Metals known to have excellent solderability, such as tin and other noble metals, etc., dissolve too easily in solders, resulting in brittle joints.

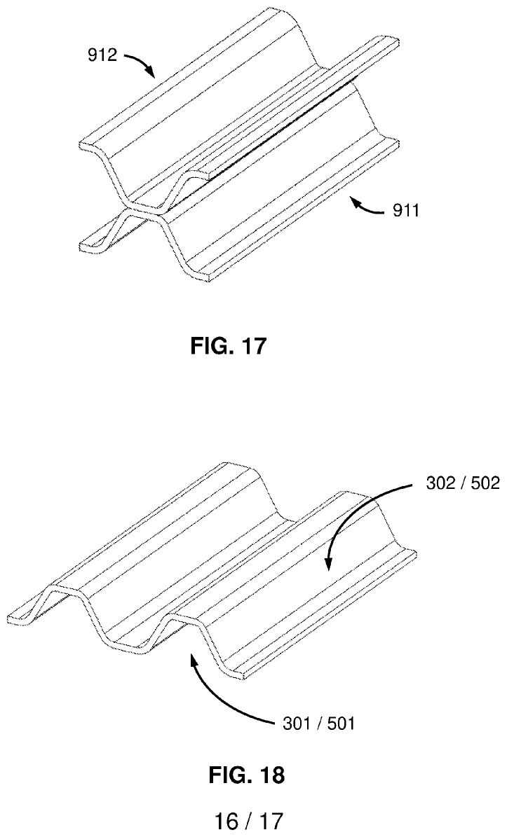

Joining bipolar plates by welding can lead to increased contact resistance and diminished corrosion resistance around the welded joints. As illustrated in FIG. 17, in a stack of conventional bipolar plates, the cathode plate 912 is a distinct and separate article from the anode plate 911. The cathode plate 912 and the anode plate 911 have to be welded together, necessitating additional manufacturing steps, and resulting in a bulky welded stack. Metal corrosion at welded joints can also be an issue. Over time, gas leakage may occur at the welded joints.

In contrast, in a stack of the proposed bipolar plates 300, there is no need to weld adjacent ones of the proposed bipolar plates 300 together, thus avoiding these and other issues related to welded joints. In addition to eliminating the need for welded joints, the proposed bipolar plate 300 can minimize contact resistance between adjacent bipolar plates 300.

In a stack of the present disclosure, the cathode and the anode are respectively provided at opposite surfaces 302/301 (cathode face 502 and anode face 501) of the same bipolar plate 300 (FIG. 18). This further enables the overall height of the stack of the present disclosure to be lower than the overall height of a conventional stack, for the same number of reaction layers 112.

### Further Industrial Applications

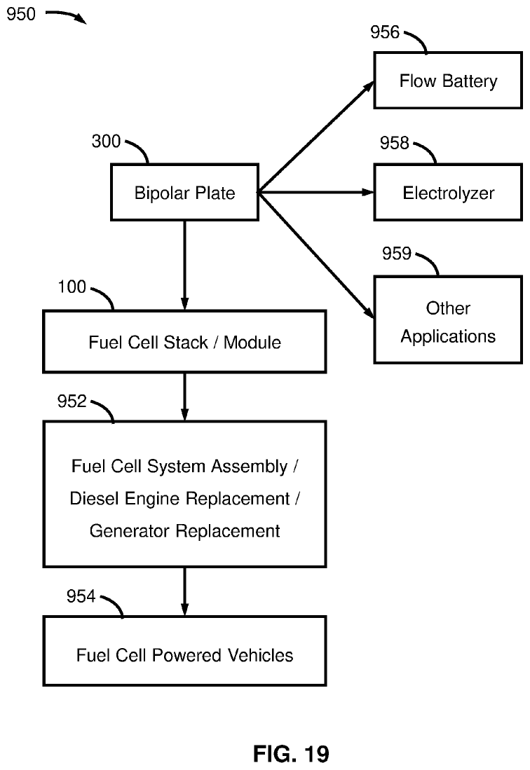

FIG. 19 diagrammatically maps out a supply chain 950 and various applications of the proposed bipolar plate 300. The proposed bipolar plate 300 may be built into a fuel cell stack or a module 100. The fuel cell stack or module 100 may be integrated into a fuel cell system assembly 952 to replace the conventional diesel engine or diesel-powered generator. The proposed bipolar plate 300 has the potential to make the fuel cell stack or module 100 smaller or more compact and lighter in weight, making it a practical option to replace the engine or a generator on board a vehicle. For example, the fuel cell system assembly 952 may be installed in various types of automotives and vehicles, including heavy-duty trucks, buses, etc. The fuel cell stack or module 100 is but one exemplary application of the proposed bipolar plate 200. Other applications envisioned for the proposed bipolar plate 300 include, but are not limited to, flow batteries 956 and electrolyzers 958. In general, the proposed bipolar plate and assemblies thereof may also be used in various other applications 959 involving gaseous and/or liquid distribution with current collection functions.

Alternatively described, according to various embodiments of the present disclosure, the bipolar plate includes a unitary body, the unitary body having a first surface, a second surface, a primary zone, a border, two or more apertures and a plurality of channel elements. The second surface is opposite the first surface. The primary zone defines a first plane. The border is continuous along an entire perimeter of the primary zone. The border extends away from the primary zone to form a flange wholly disposed on a second plane. The second plane is parallel to and axially spaced apart from the first plane to define a full height between the first plane and the second plane. The two or more apertures include an inlet and an outlet, both the inlet and the outlet are defined in the primary zone at one of the first surface and the second surface.

The planar flow path is defined by a flow height relative to the first plane, the flow height is a uniform full height from the inlet to the outlet.

The bipolar plate may further include an aperture wall partially disposed about each of the two or more apertures. Each of the two or more apertures extends through a thickness of the unitary body between a first opening defined in the primary zone at the first surface and a second opening defined in the primary zone at the second surface. The aperture wall disposed at the first opening forms a corresponding recessed element at the second surface, the recessed element is partially disposed about the second opening.

Another aperture wall disposed at the second opening forms another corresponding recessed element at the first surface.

Each of the plurality of channel elements is non-contiguous with the border.

Each of the plurality of channel elements is characterized by the full height relative to the first plane.

A first of the plurality of aperture walls is spaced apart from the first opening to define an inner flow zone therebetween, and the first of the plurality of aperture walls is spaced apart from the border to define an outer flow zone therebetween, the first of the plurality of aperture walls define a slot channel in fluid communication with the inner flow zone and the outer flow zone, the slot channel is characterized by the full height.

The plurality of channel elements may further include one or more first guide channels extend at the first surface between two selected ones of the two or more apertures, and the one or more guide channels form a corresponding one or more second guide channels extend at the second surface between another two selected ones of the two or more apertures.

The bipolar plate is characterized by a rotational symmetry of order two, the rotational symmetry is defined relative to an axis normal to the first plane.

In another aspect, the present disclosure describes a module including a plurality of a bipolar plate. Each of the plurality of the bipolar plate is a unitary body having a first surface, a second surface, a primary zone, a border, a plurality of apertures and a plurality of channel elements. The second surface is opposite the first surface. The primary zone defines a first plane. The border is continuous along an entire perimeter of the primary zone. The border extends away from the primary zone to form a flange wholly disposed on a second plane. The second plane is parallel to and axially spaced apart from the first plane to define a full height between the first plane and the second plane. The plurality of apertures are defined in the primary zone and non-contiguous with the border, each of the plurality of apertures providing fluidic communication through a thickness of the unitary body between the first surface and the second surface. The plurality of channel elements is formed wholly in the primary zone and characterized by the full height relative to the first plane to at least partially define a planar flow path from one of the plurality of apertures to another of the plurality of apertures along one of the first surface and the second surface, the plurality of channel elements being non-contiguous with the border. The plurality of the bipolar plate are stacked together along an axis normal to the first plane.

Each of the two or more apertures extends between a first opening defined in the primary zone at the first surface and a second opening defined in the primary zone at the second surface. The plurality of channel elements includes a first of an aperture wall at the first surface, the first of the aperture wall being partially disposed about the first opening of a selected aperture. The first of the aperture wall forms a corresponding first of a recessed element at the second surface, the first of the recessed element being partially disposed about the second opening of the selected aperture, the selected aperture being one selected from the two or more apertures.

The plurality of channel elements further includes a second of the recessed element at the first surface, the second of the recessed element forming a corresponding second of the recessed element at the second surface.

Each of the plurality of channel elements is non-contiguous with the border.

Each of the plurality of channel elements is characterized by the full height relative to the first plane.

The first of the plurality of aperture walls is spaced apart from the first opening to define an inner flow zone therebetween. The first of the plurality of aperture walls is spaced apart from the border to define an outer flow zone therebetween, the first of the plurality of aperture walls defining a slot channel in fluid communication with the inner flow zone and the outer flow zone, the slot channel having the full height.

The plurality of channel elements further includes one or more first guide channels extending at the first surface between two selected ones of the two or more apertures, and the one or more guide channels form a corresponding one or more second guide channels extending at the second surface between another two selected ones of the two or more apertures.

The module may further include a gasket disposed at the inner flow zone about any one of the first opening and the second opening. The gasket provides a closure of the slot channel. The gasket may include a closed ring. The gasket may include a C-shaped gasket.

The plurality of apertures may include a pair of cathode inlet/outlet in fluid communication with only one of the first surface and the second surface of a selected one of the plurality of bipolar plates, the plurality of apertures may include a pair of anode inlet/outlet in fluid communication with only another of the first surface and the second surface of the selected one of the plurality of bipolar plates.

The plurality of apertures may include a pair of cathode inlet/outlet; a pair of anode inlet/outlet; and a pair of coolant inlet/outlet, in which the pair of coolant inlet/outlet is in fluid communication with one of the first surface and the second surface of a selected one of the plurality of bipolar plates, and in which another of the first surface and the second surface is in fluid communication with one of the pair of cathode inlet/outlet and the pair of anode inlet/outlet.

Each of the plurality of bipolar plates is characterized by a rotational symmetry of order two, the rotational symmetry is defined relative to a normal axis, the normal axis is defined by the first plane. A first of the bipolar plate and a second of the bipolar plate are coupled together with the second bipolar plate rotated 180 degrees about the normal axis.

The module may further include a membrane clamped between the respective flanges of two sequentially disposed ones of the plurality of bipolar plates.

A fuel cell may include one or more of the modules, the one or more modules being axially assembled to one another.

In yet another aspect, the present disclosure describes a method of forming the bipolar plate. The method includes steps of: stamping a metal blank in a first direction to form the primary zone, the primary zone is displaced by a full height relative to an unstamped area; and stamping the primary zone in a second direction to form one or more channel elements nested in the primary zone, each of the one or more channel elements is displaced by the full height relative to the primary zone.

All examples described herein, whether of apparatus, methods, materials, or products, are presented for the purpose of illustration and to aid understanding, and are not intended to be limiting or exhaustive. Modifications not involving inventive effort may be made by one of ordinary skill in the art without departing from the scope of the claimed invention.

1. A bipolar plate comprising:
a unitary body having:
a first surface;
a second surface, the second surface being opposite the first surface;
a primary zone, the primary zone defining a first plane;
a border, the border being continuous along an entire perimeter of the primary zone, the border extending away from the primary zone to form a flange wholly disposed on a second plane, the second plane being parallel to and axially spaced apart from the first plane to define a full height between the first plane and the second plane;
two or more apertures including an inlet and an outlet, both the inlet and the outlet being defined in the primary zone at one of the first surface and the second surface; and
a plurality of channel elements, the plurality of channel elements being formed wholly in the primary zone and characterized by the full height relative to the first plane, at least one of the plurality of channel elements at least partially defines a planar flow path extending from the inlet to the outlet, the planar flow path being disposed on the first plane.

2. The bipolar plate as recited in claim 1, wherein the planar flow path is defined by a flow height relative to the first plane, the flow height being a uniform full height from the inlet to the outlet.

3. The bipolar plate as recited in claim 1 further comprising:
an aperture wall partially disposed about each of the two or more apertures,
wherein each of the two or more apertures extends through a thickness of the unitary body between a first opening defined in the primary zone at the first surface and a second opening defined in the primary zone at the second surface,
and wherein the aperture wall disposed at the first opening forms a corresponding recessed element at the second surface, the recessed element being partially disposed about the second opening.

4. The bipolar plate as recited in claim 3, wherein another aperture wall disposed at the second opening forms another corresponding recessed element at the first surface.

5. (canceled)

6. (canceled)

7. The bipolar plate as recited in claim 3,
wherein a first of aperture wall is spaced apart from the first opening to define an inner flow zone therebetween,
and wherein the first aperture wall is spaced apart from the border to define an outer flow zone therebetween, the first aperture wall defining a slot channel in fluid communication with the inner flow zone and the outer flow zone, the slot channel being characterized by the full height.

8. The bipolar plate as recited in claim 7, wherein the plurality of channel elements further comprises one or more first guide channels extending at the first surface between two selected ones of the two or more apertures, and wherein the one or more guide channels form a corresponding one or more second guide channels extending at the second surface between another two selected ones of the two or more apertures.

9. The bipolar plate as recited in claim 1, wherein the bipolar plate is characterized by a rotational symmetry of order two, the rotational symmetry being defined relative to an axis normal to the first plane.

10. A module, comprising:
a plurality of bipolar plates, each of the plurality of bipolar plates being a unitary body having:
a first surface;
a second surface, the second surface being opposite the first surface;
a primary zone, the primary zone defining a first plane;
a border, the border being continuous along an entire perimeter of the primary zone, the border extending away from the primary zone to form a flange wholly disposed on a second plane, the second plane being parallel to and axially spaced apart from the first plane to define a full height between the first plane and the second plane;
a plurality of apertures being defined in the primary zone and non-contiguous with the border, each of the plurality of apertures providing fluidic communication through a thickness of the unitary body between the first surface and the second surface; and
a plurality of channel elements, the plurality of channel elements being formed wholly in the primary zone and characterized by the full height relative to the first plane to at least partially define a planar flow path from one of the plurality of apertures to another of the plurality of apertures along one of the first surface and the second surface, the plurality of channel elements being non-contiguous with the border,
wherein the plurality of the bipolar plate are stacked together along an axis normal to the first plane.

11. The module as recited in claim 10, wherein each of the two or more apertures extends between a first opening defined in the primary zone at the first surface and a second opening defined in the primary zone at the second surface,
and wherein the plurality of channel elements comprises a first of an aperture wall at the first surface, the first of the aperture wall being partially disposed about the first opening of a selected aperture,
and wherein the first of the aperture wall forms a corresponding first of a recessed element at the second surface, the first of the recessed element being partially disposed about the second opening of the selected aperture, the selected aperture being one selected from the two or more apertures.

12. The module as recited in claim 11, the plurality of channel elements further comprising a second of the recessed element at the first surface, the second of the recessed element forms a corresponding second of the aperture wall at the second surface wherein each of the plurality of channel elements is characterized by the full height relative to the first plane.

13. (canceled)

14. (canceled)

15. The module as recited in claim 12,
wherein the first of the aperture wall is spaced apart from the first opening to define an inner flow zone therebetween,
and wherein the first of the aperture wall is spaced apart from the border to define an outer flow zone therebetween, the first of the aperture wall defining a slot channel in fluid communication with the inner flow zone and the outer flow zone, the slot channel having the full height.

16. The module as recited in claim 15, wherein the plurality of channel elements further comprises one or more first guide channels extending at the first surface between two selected ones of the two or more apertures, and wherein the one or more guide channels form a corresponding one or more second guide channels extending at the second surface between another two selected ones of the two or more apertures.

17. The module as recited in claim 15, further comprising a gasket disposed at the inner flow zone about any one of the first opening and the second opening.

18. The module as recited in claim 17, wherein the gasket provides a closure of the slot channel.

19. (canceled)

20. (canceled)

21. The module as recited in claim 10,
wherein the plurality of apertures comprises a pair of cathode inlet/outlet in fluid communication with only one of the first surface and the second surface of a selected one of the plurality of bipolar plates,
and wherein the plurality of apertures comprises a pair of anode inlet/outlet in fluid communication with only another of the first surface and the second surface of the selected one of the plurality of bipolar plates.

22. The module as recited in the claim 10, wherein the plurality of apertures comprises:
a pair of cathode inlet/outlet;
a pair of anode inlet/outlet; and
a pair of coolant inlet/outlet, wherein the pair of coolant inlet/outlet is in fluid communication with one of the first surface and the second surface of a selected one of the plurality of bipolar plates, and wherein another of the first surface and the second surface is in fluid communication with one of the pair of cathode inlet/outlet and the pair of anode inlet/outlet.

23. The module as recited in claim 10, wherein each of the plurality of bipolar plates is characterized by a rotational symmetry of order two, the rotational symmetry being defined relative to a normal axis, the normal axis being defined by the first plane.

24. The module as recited in claim 23, wherein a first of the plurality of bipolar plates and a second of the plurality of bipolar plates are coupled together with the second bipolar plate rotated 180 degrees about the normal axis.

25. The module as recited in claim 10, further comprising a membrane, the membrane being clamped between the respective flanges of two sequentially disposed ones of the plurality of bipolar plates.

26. (canceled)

27. A method of forming the bipolar plate of claim 1, comprising:
stamping a metal blank in a first direction to form the primary zone, the primary zone being displaced by a full height relative to an unstamped area; and
stamping the primary zone in a second direction to form one or more channel elements nested in the primary zone, each of the one or more channel elements being displaced by the full height relative to the primary zone
